(19) United States
(12) Patent Application Publication
(10) Pub. No.: US 2025/0164809 A1
(43) Pub. Date: May 22, 2025

(54) NEAR-TO-EYE DISPLAY ASSEMBLY, DEVICE, AND WEARABLE DEVICE

(71) Applicant: Shenzhen Arcension Technology Co.,Ltd., SHENZHEN (CN)

(72) Inventors: Yingnan ZHAI, SHENZHEN (CN); Jieyang JIA, SHENZHEN (CN); Xudong DENG, SHENZHEN (CN); Yanzhi CHEN, SHENZHEN (CN)

(21) Appl. No.: 18/412,810

(22) Filed: Jan. 15, 2024

(30) Foreign Application Priority Data
Nov. 17, 2023 (CN) 202323123689.0

(51) Int. Cl. G02B 27/01

(52) U.S. Cl. CPC G02B 27/0176; G02B 2027/0178

(57) ABSTRACT

The present application provides a near-to-eye display assembly, a near-to-eye display device, and a wearable device. The near-to-eye display assembly includes an installation base and a first connecting part. The installation base is configured for installing an optical engine. The first connecting part is connected to the installation base and configured for connecting to the optical lens. The first connecting part defines an accommodating groove. The installation base includes a first section and a second section connected to the first section, the first section defines an installation groove configured for installing the optical engine, and the second section is embedded in the accommodating groove. A first electrical component storing chamber configured for installing an electrical component is formed between the accommodating groove and the second section, and the electrical component is electrically connected to the optical engine.

### CROSS-REFERENCE TO RELATED DISCLOSURES

The present application claims priority to Chinese patent application No. 202323123689.0, entitled “NEAR-TO-EYE DISPLAY ASSEMBLY AND DEVICE”, filed Nov. 17, 2023, which is herein incorporated by reference in its entirety.

### TECHNICAL FIELD

The present disclosure relates to the field of wearable technologies, and in particular to a near-to-eye display assembly, a near-to-eye display device, and a wearable device.

### BACKGROUND

Near-to-eye display is a technology that creates a virtual image in a monocular or binocular field of view. Near-to-eye display uses a display device placed in a non-bright distance of the human eye to render light field information to the human eye, thereby reconstructing a virtual scene in front of the eyes.

In general, a near-to-eye display device is usually a head mounted display or other wearable display, located in front of human vision, with a relatively complex structure that affects product production efficiency.

### SUMMARY OF THE DISCLOSURE

A technical solution adopted in the present disclosure is to provide a near-to-eye display assembly for an optical lens, including an installation base and a first connecting part.

The installation base is configured for installing an optical engine.

The first connecting part is connected to the installation base and configured for connecting to the optical lens. The first connecting part defines an accommodating groove, the installation base includes a first section and a second section connected to the first section, the first section defines an installation groove configured for installing the optical engine, and the second section is embedded in the accommodating groove; and a first electrical component storing chamber configured for installing an electrical component is formed between the accommodating groove and the second section, and the electrical component is electrically connected to the optical engine.

On the basis of the aforementioned near-to-eye display assembly, the present disclosure further provides a near-to-eye display device including an optical lens and any of the near-to-eye display assemblies as mentioned above.

The first connecting part of the near-to-eye display assembly is connected to the optical lens.

On the basis of the aforementioned near-to-eye display device, the present disclosure further provides a wearable device, including any of the near-to-eye display assemblies or any of the near-to-eye display devices as described above.

### BRIEF DESCRIPTION OF THE DRAWINGS

In order to more clearly illustrate the technical solutions in some embodiments of the present disclosure, hereinafter, a brief introduction will be given to the accompanying drawings that are used in the description of some embodiments. Obviously, the accompanying drawings in the description below are merely some embodiments of the present disclosure. For those of ordinary skill in the art, other accompanying drawings may be obtained based on these accompanying drawings without any creative efforts.

FIG. 1 is a structural schematic view of AR glasses in some embodiments of the present disclosure.

FIG. 2 is a structural schematic view of a near-to-eye display assembly in some embodiments of the present disclosure.

FIG. 3 is an exploded schematic view of FIG. 2.

FIG. 4 is a front view of FIG. 2.

FIG. 5 is a cross-sectional structural schematic view along 4A-4A of FIG. 4.

FIG. 6 is a structural schematic view of an installation base in some embodiments of the present disclosure.

FIG. 7 is an exploded schematic view of the near-to-eye display assembly in some embodiments of the present disclosure.

FIG. 8 is a cross-sectional structural schematic view of the near-to-eye display assembly in some embodiments of the present disclosure.

FIG. 9 is a structural schematic view of the installation base in some embodiments of the present disclosure.

FIG. 10 is a structural schematic view of a first connecting part in some embodiments of the present disclosure.

FIG. 11 is a structural schematic view illustrating the near-to-eye display assembly and a second connecting part in some embodiments of the present disclosure.

FIG. 12 is a structural schematic view of the second connecting part in some embodiments of the present disclosure.

Explanation of reference signs: 1-near-to-eye display assembly; 10-installation base; 11 -first section; 111-installation groove; 12-second section; 121-via; 1211-first via; 1212-first wiring groove; 1213-second via; 1214-second wiring groove; 1215-guide groove; 1216-clamping groove; 13-fixed base; 131-fixed groove; 132-second electrical component storing chamber; 14-first connecting part; 141-accommodating groove; 142-first electrical component storing chamber; 143-convex block; 15-first conductive member; 151-connecting part; 152-annular part; 2-optical lens; 3-battery; 4-optical engine; 41-micro display; 42-display module; 5-second connecting part; 51-sleeve; 52-protective component; 53-magnet; 6-glasses frame.

### DETAILED DESCRIPTION

The technical solutions in some embodiments of the present disclosure may be clearly and completely described in conjunction with accompanying drawings in some embodiments of the present disclosure. Obviously, the described embodiments are only a part of the embodiments of the present disclosure, and not all embodiments. Based on the embodiments in the present disclosure, all other embodiments obtained by those of ordinary skill in the art without creative effort are within the scope of the present disclosure.

In the description of the present disclosure, the directions or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, etc. are based on the methods or positional relationships shown in the accompanying drawings. It is only intended to facilitate the description of the embodiments of the present disclosure and simplify the description, but does not indicate or imply that the device or the element referred to must have a specific orientation, be constructed and operated in a specific orientation. Therefore, it cannot be understood as a limitation on the embodiments of the present disclosure. The terms “first” and “second” in the present disclosure are only configured to describe purposes and cannot be understood as indicating or implying relative importance or implicit indicating the quantity of technical features indicated. Therefore, features limited to “first” and “second” may explicitly or implicitly include at least one of these features. In the description of the present disclosure, “multiple” or “a plurality of” means two or more, unless otherwise expressly and specifically qualified.

In the present disclosure, the term “exemplary” or “embodiment” is configured to indicate “used as an example, illustration, or explanation”. Any embodiment described as “exemplary” in the present disclosure may not necessarily be interpreted as more preferred or advantageous than other embodiments. In order to enable any those of ordinary skill in the art to implement and use the present disclosure, the following description is provided. In the following description, details are listed for explanatory purposes. It should be understood that those of ordinary skill in the art may recognize that the present disclosure may also be implemented without using these specific details. In other examples, the structure and process of public knowledge may not be elaborated in detail, to avoid unnecessary details that may obscure the description of the present disclosure. Thus, the present disclosure is not intended to limit the embodiments shown, but is consistent with the widest scope of principles and features disclosed herein.

The term “multiple” or “a plurality of” in embodiments of the present disclosure refers to at least two (including two).

A near-to-eye display device, also known as a head mounted display or a wearable display, is applied to an optical lens. In some cases, at a technical level, augmented reality (AR), virtual reality (VR), mixed reality (MR), and extended reality (XR) may all be referred to as the near-to-eye display. The optical lens in the embodiments of the present disclosure may be goggles, smart glasses, nearsightedness glasses, hyperopia glasses, sports glasses, or other near-to-eye or head mounted optical lenses, etc. A user's optical lense may face the glasses. The near-to-eye display device has an optical engine. The optical engine may include a micro display, such as a Micro-LED (Micro Light-Emitting Diode), an uLED (Micro Light-Emitting Diode), a Micro-OLED (Micro Organic Light-Emitting Diode), an LCOS (Liquid Crystal On Silicon), an LCD (Liquid Crystal Display), a DMD (Digital Micromirror Device), DLP (Digital Light Processing), a LBS (Laser Beam Scanning), or any combination of these technologies. The optical engine may also include a micro-optical module, etc. The micro-optical module is disposed in front of the micro display, and a light ray from the display is emitted after passing through the micro-optical module.

The near-to-eye display device may also include a circuit board, a battery configured for supplying power to the optical engine and the circuit board, and electrical components configured for achieving electrical connections between various components and the battery. In the embodiments of the present disclosure, the circuit board and the battery may be collectively referred to as electrical components. Taking the AR glasses as an example, in general, the circuit board, the battery, and other electrical components are installed on glasses legs of the AR glasses, and the optical engine is installed on the optical lens. There are passages for wiring outside the optical engine, which is easy to supply power to the optical engine. In some cases, the glasses legs of the AR glasses need to rotate relative to the glasses frame, so that the connection between the electrical components such as the optical engine and the battery may be affected by the relative movement of the glasses legs, resulting in relative misalignment and short circuits in the wiring of the electrical components such as the optical engine and the battery. With the relative movement of the glasses legs, the wiring parts of the electrical components such as the optical engine and the battery are also prone to water ingress, which affects the use of AR glasses.

In the embodiments of the present disclosure, a near-to-eye display assembly for the optical lenses is provided. The near-to-eye display assembly includes an installation base and a first connecting part. In the embodiments of the present disclosure, the first connecting part is connected to the installation base, to facilitate fixing the optical engine at a predetermined position on the optical lens. A first electrical component storing chamber is disposed on the first connecting part, it is easy to install the battery and other electrical components on the first connecting part, thereby reducing the need for additional installation of the battery and other components on the wearable device, facilitating the assembly of the near-to-eye display assembly on the device, and helping to improve the reliability of the wearable device. In some application scenarios, the near-to-eye display assembly may be operated independently without connecting the electrical components of the glasses legs (such as displaying image content, etc.), greatly improving the portability and mobility of display assembly products. The near-to-eye display assembly may be compatible with other traditional head mounted devices, such as near and far vision, eye protection, helmets, etc., and the application scenarios are more diverse.

The present disclosure provides a near-to-eye display assembly, a near-to-eye display device, and a wearable device, aiming to simplify a structure of the near-to-eye display assembly.

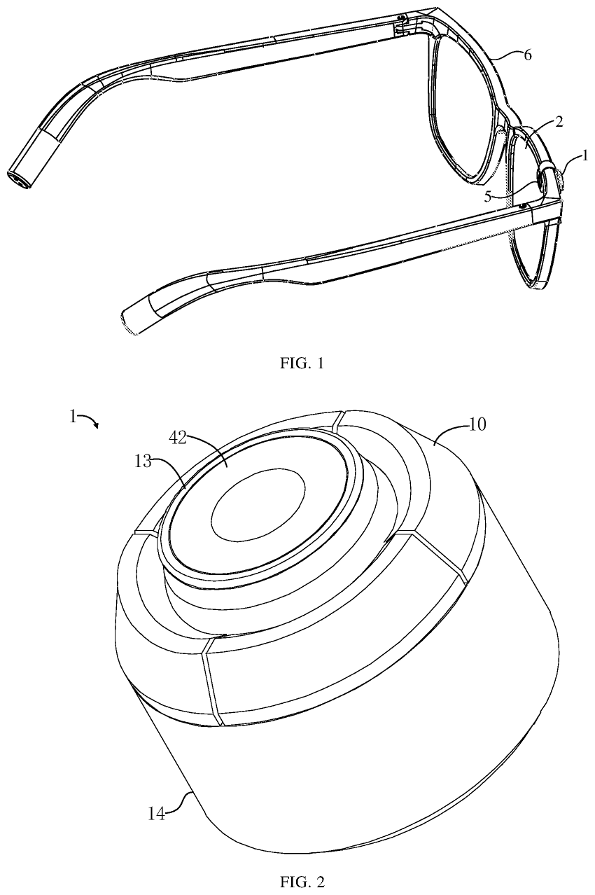

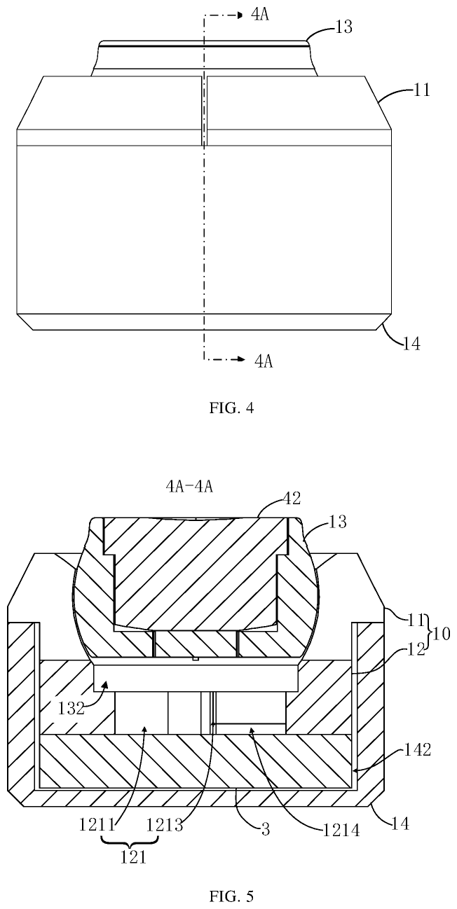

As illustrated in FIGS. 1 to 5, the near-to-eye display assembly 1 in some embodiments of the present disclosure may be configured for the AR glasses, the near-to-eye display assembly 1 is installed on the optical lens 2 and/or glasses frame 6 of the AR glasses, and the first connecting part 14 of the near-to-eye display assembly 1 may be installed on an inner side or an outer side of the optical lens 2. By disposing a first electrical component storing chamber 142 on the first connecting part 14, the battery 3 and other electrical components of the near-to-eye display assembly 1 may be integrated into the optical lens 2, which may reduce the installation of battery 3 or the circuit board on the glasses legs of the AR glasses, may reduce the electrical connections between the glasses legs and the glasses frame 6 of the AR glasses, thereby reducing the problem of an open circuit, a short circuit, or water ingress caused by the movement of the glasses legs relative to the glasses frame 6.

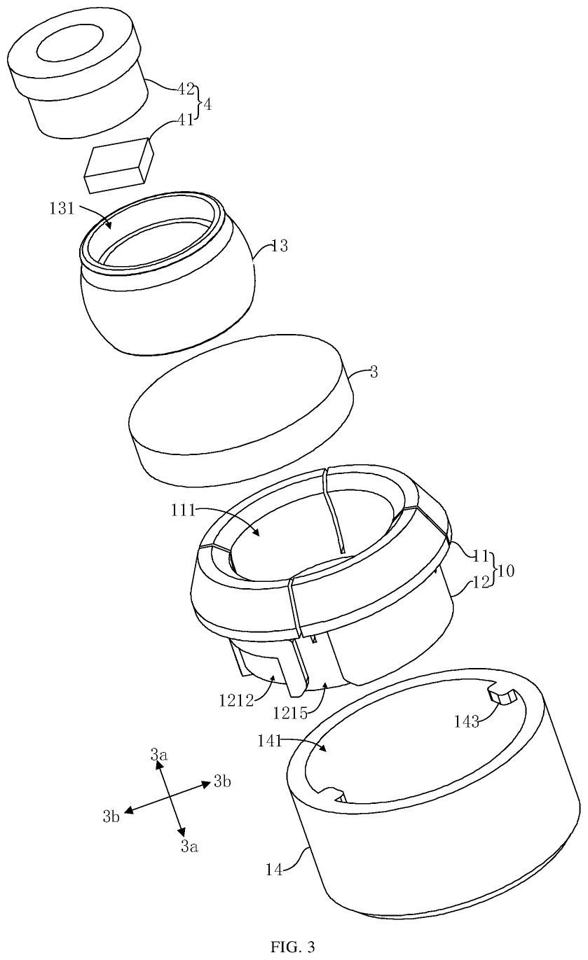

As illustrated in FIGS. 2 to 5, the embodiments of the present disclosure provide the near-to-eye display assembly 1 for the optical lens 2. The near-to-eye display assembly 1 includes an installation base 10 and the first connecting part 14. The installation base 10 is configured for installing an optical engine 4. The first connecting part 14 is connected to the installation base 10 and configured for being connected to the optical lens 2. The first connecting part 14 defines an accommodating groove 141. The installation base 10 includes a first section 11 and a second section 12 connected to the first section 11. An installation groove 111 is defined in the first section 11, and the second section 12 is embedded in the accommodating groove 141. A first electrical component storing chamber 142 is disposed between the accommodating groove 141 and the second section 12. The first electrical component storing chamber 142 is configured for installing the electrical components, and the electrical components are electrically connected to the optical engine 4.

As illustrated in FIGS. 3 and 5, the installation base 10 is configured to install the optical engine 4. In some embodiments, the optical engine 4 may include a micro display 41 and a display module 42 as described above. In some embodiments, the optical engine 4 may be fixedly connected to the installation base 10, and the optical engine 4 may also be movably connected to the installation base 10 relative to the installation base 10. In some embodiments, when the optical engine 4 is movably connected to the installation base 10 relative to the installation base 10, the optical engine 4 may rotate relative to the installation base 10 around a preset rotation center, the optical engine 4 may also move along a preset path on the installation base 10. The optical engine 4 may rotate relative to the installation base 10 and move relative to the installation base 10. In some embodiments, the installation groove 111 is defined in the installation base 10 and configured for installing the optical engine 4. The installation groove 111 may be a through groove that runs through the installation base 10 or a sinking groove defined in the installation base 10, and the optical engine 4 is installed in the installation groove 111. In some embodiments, the optical engine 4 installed in the installation groove 111 may be that at least part of the optical engine 4 is located in the installation groove 111 and fixedly connected to the installation base 10, or at least part of the optical engine 4 is located in the installation groove 111 and movably connected to the installation groove 111. In some embodiments, the optical engine 4 may be directly installed in the installation groove 111, and the optical engine 4 may also be installed in the installation groove 111 through an intermediate connector.

As illustrated in FIGS. 3 and 5, the first connecting part 14 may serve as a main structure of the near-to-eye display assembly 1, configured to connect to the optical lens 2. In some embodiments, a fixed surface may be disposed on the first connecting part 14, and the fixed surface is configured to be connected to the optical lens 2. In some embodiments, the first connecting part 14 may be directly connected to the optical lens 2, or may be connected to the optical lens 2 through other intermediate connectors. The optical engine 4 has an out-light surface. In some embodiments, the fixed surface of the first connecting part 14 may be an end face on one side of the first connecting part 14 away from the out-light surface of the optical engine, and the fixed surface may also be other surfaces of the first connecting part 14. In some embodiments, the first connecting part 14 may be fixedly connected to the optical lens 2. For example, the first connecting part 14 may be bonded to the optical lens 2 to maintain a relatively fixed position on the optical lens 2. In some embodiments, the first connecting part 14 may be movably installed on the optical lens 2. For example, the first connecting part 14 may be slidably or rotatably connected to the optical lens 2. In some embodiments, the first connecting part 14 may also be detachably installed on the optical lens 2. For example, the first connecting part 14 may be clamped or adsorbed on the optical lens 2.

As illustrated in FIGS. 3 and 5, at least part of the first connecting part 14 is hollow to form the accommodating groove 141. The first electrical component storing chamber 142 is configured for installing the electrical components. In the embodiments of the present disclosure, the electrical components include, but are not limited to, the battery 3, the circuit board, etc. For illustrative purposes, the following description is an explanation of the battery 3 installed in the first electrical component storing chamber 142.

In some embodiments, taking the AR device as an example, the electrical components, such as the battery 3, may be directly installed in the first electrical component storing chamber 142, so that additional electrical components for connecting the optical engine 4 and the battery 3 at the connection between the glasses legs and the glasses frame 6 of the AR equipment may be reduced. On the one hand, the problem of water ingress or wear on the electrical components caused by the relative movement of the glasses legs and the glasses frame 6 may be reduced. On the other hand, the complexity of the connection between the glasses legs and the glasses frame 6 may be reduced, thereby simplifying the structure of the AR device and improving the assembly property of the product.

In some embodiments, a via 121 may be directly defined in the first connecting part 14, and the via 121 is configured to connect the first electrical component storing chamber 142 and the optical engine 4, in order to connect the electrical components and the optical engine 4 in the near-to-eye display assembly 1 through the electrical components. By installing the electrical components, such as the battery 3, inside the first connecting part 14, the wiring structure outside the first connecting part 14 or the installation base 10 may be reduced. When packaging the AR device, the packaging operation may be simplified and the production efficiency of the product may be improved. In some embodiments, the via 121 may also be defined in the first connecting part 14, and the via 121 is configured to connect the first electrical component storing chamber 142 and an outer wall of the first connecting part 14. The electrical structure passing through the via 121 may be connected to the battery 3 in the first electrical component storing chamber 142 and the optical engine 4.

In some embodiments, an inner wall of the first electrical component storing chamber 142 may be enclosed to form a cylindrical or rectangular cavity, and a shape of the first electrical component storing chamber 142 may be adapted to a shape of the electrical component. The optical engine 4 has the out-light surface, and the light ray from the optical engine 4 enters the human eye through the out-light surface. An optical axis of the optical engine 4 may be perpendicular to the out-light surface of the optical engine 4. In some embodiments, the first electrical component storing chamber 142 may be located on one side of the installation base 10 away from the out-light surface of the optical engine 4, so that the battery 3 and other electrical components are located on the side of the installation base 10 away from the out-light surface of the optical engine 4. A conductive module of the optical engine 4 (not shown in the figure) may pass through the installation base 10 and be connected to the electrical components. Taking a direction 3a in FIG. 3 being an axial direction of the installation groove 111 and a direction 3b being a radial direction of the installation groove 111 as an example, in some embodiments, the first electrical component storing chamber 142 is disposed on the side of the installation base 10 away from the out-light surface of the optical engine 4, so that a width of the near-to-eye display assembly 1 in the radial direction of the installation groove 111 may be reduced, thereby reducing obstruction caused by the near-to-eye display assembly 1 on the optical lens 2 and improving the comfortable capability of the wearable device. In some embodiments, each of the installation groove 111 and the first electrical component storing chamber 142 has the axial direction, and the axis of the first electrical component storing chamber 142 may be aligned with the axial direction of the installation groove 111. Taking the electrical component being the battery 3 as an example, when installing the battery 3, the battery 3 may be coaxial with the installation groove 111, to reduce the volume of the electrical component such as the battery 3 in the radial direction of the installation groove 111.

In some embodiments, the difference from the previous embodiments is that each of the installation groove 111 and the first electrical component storing chamber 142 has the axis. The first electrical component storing chamber 142 may be disposed on one side of the radial direction of the installation groove 111, or the axis of the installation groove 111 may be disposed in a staggered position with the axis of the first electrical component storing chamber 142, to facilitate expansion of the first electrical component storing chamber 142 and integration of more electrical components in the first electrical component storing chamber 142.

As illustrated in FIGS. 3 and 5, in some embodiments, the first electrical component storing chamber 142 is formed between the end face of the side of the second section 12 away from the first section 11 and a bottom wall of the accommodating groove 141. The first connecting part 14 has an opening configured to communicate with the accommodating groove 141, and the accommodating groove 141 has the bottom wall opposite to the opening. The second section 12 may enter the accommodating groove 141 through the opening of the first connecting part 14. The first electrical component storing chamber 142 is formed between the end face of the side of the second section 12 away from the first section 11 and the bottom wall of the accommodating groove 141, so that a geometric center of the first electrical component storing chamber 142 may be as close as possible to the axis of the installation groove 111, thereby reducing the volume of the first electrical component storing chamber 142 in the radial direction of the installation groove 111. Due to the fact that the end face of the side of the second section 12 away from the first section 11, may directly enclose with the bottom wall of the accommodating groove 141 to form the first electrical component storing chamber 142, when installing the installation base 10, the installation base 10 may quickly enclose with the first connecting part 14 to form the first electrical component storing chamber 142, thereby simplifying the structure of the near-to-eye display assembly 1. The first electrical component storing chamber 142 is configured for installing the electrical components. In some embodiments, the inner wall surface of the accommodating groove 141 may be adhered to the outer wall of the installation base 10, so that after the installation base 10 is connected to the first connecting part 14, it is convenient to seal the first electrical component storing chamber 142, thereby reducing the water ingress problem of the first electrical component storing chamber 142 and improving the sealing property of the first electrical component storing chamber 142.

As illustrated in FIGS. 3 and 5, in some embodiments, the first electrical component storing chamber 142 is located on the side of the second section 12 away from the first section 11.

The second section 12 of the installation base 10 is configured to connect the first connecting part 14. The first section 11 of the installation base 10 is connected to the second section 12 to form the installation groove 111, the installation groove 111 is configured for installing the optical engine 4, so as to connect the optical engine 4 to the installation base 10. In some embodiments, the first section 11 may be integrated with the second section 12, and the first section 11 may also be separated and connected to the second section 12. In some embodiments, the installation groove 111 may be the through groove defined in the first section 11, and the installation groove 111 may also be the sinking groove defined in the first section 11.

At least part of the first connecting part 14 is hollow, and the accommodating groove 141 is a cavity defined in the first connecting part 14. The first connecting part 14 has the opening communicated with the accommodating groove 141, and the second section 12 of the installation base 10 may be embedded in the accommodating groove 141 through the opening of the first connecting part 14. In some embodiments, by adopting an internal and external embedded installation mode, it is convenient to seal the installation base 10 and the first connecting part 14, thereby improving the sealing property and waterproofing property of the near-to-eye display assembly 1.

The first electrical component storing chamber 142 is located on the side of the second section 12 away from the first section 11, which means that the first electrical component storing chamber 142 may be located on the side of the second section 12 away from the first section 11; or the first electrical component storing chamber 142 may be located on the side of the second section 12 away from the first section 11, and is partially staggered with the end face of the side of the second section 12 away from the first section 11. In some embodiments, by disposing the first electrical component storing chamber 142 on the side of the second section 12 away from the first section 11, on the one hand, the first electrical component storing chamber 142 may be staggered with the installation groove 111 to reduce mutual interference between the electrical components and the optical engine 4; on the other hand, it may facilitate the expansion of the first electrical component storing chamber 142. On the other hand, a direction of the second section 12 towards the first section 11 is a first direction, and a direction perpendicular to the first direction is a second direction. In some embodiments, the first direction may be the axial direction of the installation groove 111 of the installation base 10, as shown in the 3a direction in FIG. 3, and the second direction may be the radial direction of the installation groove 111, as shown in the 3b direction in FIG. 3. Due to the first electrical component storing chamber 142 being staggered with the optical engine 4, the geometric center of the first electrical component storing chamber 142 may be as close as possible to the axis position of the installation groove 111, thereby reducing the volume of the near-to-eye display assembly 1 in the radial direction of the installation groove 111 and reducing the obstruction of the near-to-eye display assembly 1 on the optical lens 2.

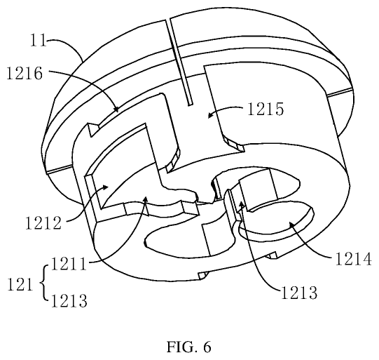

As illustrated in FIGS. 5 and 6, in some embodiments, the via 121 is defined in the installation base 10 and configured for accommodating the conductive module of the optical engine 4. The installation groove 111 is communicated with the first electrical component storing chamber 142 through the via 121. The conductive module is configured for being connected to the electrical components. The conductive module of the optical engine 4 may be a structure that may electrically connect the optical engine 4 to the electrical components, such as a wire, a flexible circuit board, or a copper plating layer. The via 121 is a through hole that runs through the installation base 10. One end of the via 121 is connected to the installation groove 111, and the other end of the via 121 is connected to the first electrical component storing chamber 142, so that the conductive module of the optical engine 4 may pass through the via 121 and extend into the first electrical component storing chamber 142, facilitating the electrical connection between the optical engine 4 and the corresponding electrical component. In some embodiments, taking the electrical component being the battery 3 as an example, the conductive module of the optical engine 4 may be configured to be connected to a positive pole or a negative pole of the battery 3. In some embodiments, by disposing the via 121, the conductive module of the optical engine 4 may pass through the installation base 10 to reduce the exposure of the conductive module, thereby facilitating the sealing and waterproof treatment of the near-to-eye display assembly 1, and improving the sealing property and waterproof property of the near-to-eye display assembly 1. In some embodiments, the first electrical component storing chamber 142 is formed between the end face of the side of the second section 12 away from the first section 11 and the bottom wall of the accommodating groove 141. The via 121 may extend along a direction parallel to the axis of the installation groove 111, or the via 121 may pass through the outer wall of the second section 12, and may be communicated with the first electrical component storing chamber 142 through the gap between the outer wall of the second section 12 and the inner wall of the accommodating groove 141. In some embodiments, the number of the vias 121 may be one, and the conductive module of the optical engine 4 may pass through the via 121 and be connected to the electrical component in the first electrical component storing chamber 142. In some embodiments, the number of the vias 121 may be multiple, and the conductive module of the optical engine 4 may respectively pass through multiple vias 121 and be connected to the electrical components in the first electrical component storing chamber 142. In some embodiments, the conductive module of the optical engine 4 may be directly electrically connected to the electrical component, and the conductive module of the optical engine 4 may also be electrically connected to the electrical component through the intermediate connector.

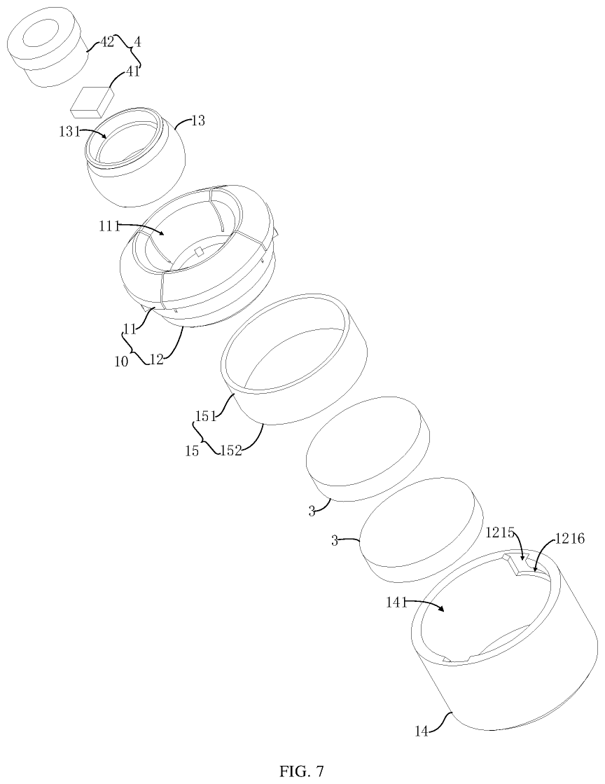

As illustrated in FIGS. 7, 8, and 9, in some embodiments, at least one of the second section 12 and the first connecting part 14 defines a first wiring groove 1212 that is communicated with the first electrical component storing chamber 142 and the via 121. The first wiring groove 1212 is configured for the conductive module to pass through and be connected to the electrical component.

The first wiring groove 1212 is configured for accommodating the conductive module, and at least one of the second section 12 and the first connecting part 14 defines the first wiring groove 1212 to form a space for accommodating the conductive module. In some embodiments, the first wiring groove 1212 may be a groove located on the inner wall surface of the accommodating groove 141. The first wiring groove 1212 may also be a groove located on the second section 12. Alternatively, both the outer surface of the second section 12 and the inner wall surface of the accommodating groove 141 define the grooves, and the groove on the second section 12 and the groove on the inner wall surface of the accommodating groove 141 may be combined to form the first wiring groove 1212. For illustrative purposes, in the embodiments of the present disclosure, the first wiring groove 1212 being the groove defined on the outer wall surface of the second section 12 is taken as an example to illustrate. In some embodiments, the part of the conductive module located in the first wiring groove 1212 may be a wire, a flexible circuit board, or a copper plating layer. A material of the part of the conductive module located in the via 121 and a material of the part of the conductive module located in the first wiring groove 1212 may be the same or different. For example, in some embodiments, the part of the conductive module located in the via 121 may be the flexible circuit board or the wire, and the part of the conductive module located in the first wiring groove 1212 may be the copper plating layer or a metal sheet.

In some embodiments, by disposing the first wiring groove 1212 that is communicated with the via 121 and the first electrical component storing chamber 142, it is convenient to form the space for accommodating the conductive module, so that the second section 12 may better cooperate with the first connecting part 14 to seal the installation base 10 and the first connecting part 14.

In some embodiments, the number of the conductive modules is multiple, and multiple conductive modules are configured to be connected to the electrical components. The near-to-eye display assembly 1 further includes a first conductive member 15, and the first conductive member 15 is configured for connecting the electrical component and corresponding conductive module, and at least part of the first conductive member 15 is located in the first wiring groove 1212.

In some embodiments, the number of the conductive modules is multiple, which refers to that the optical engine 4 is connected to the electrical components through multiple electrical elements. Taking the electrical component being the battery 3 as an example, the optical engine 4 may be connected to the positive pole or the negative pole of the battery 3 through multiple conductive modules. In some embodiments, the materials of the multiple conductive modules may be the same material or different materials. For example, at least one conductive module may be the flexible circuit board, while the other conductive modules may be the copper plating layer or the wires.

The first conductive member 15 is configured to connect the electrical component and the corresponding conductive module, which refers to that the first conductive member 15 electrically connects the corresponding functional module of the electrical component to the corresponding functional module of the optical engine 4. For example, the first conductive member 15 may be configured to connect the positive pole or the negative pole of the optical engine 4 to the battery 3. In some embodiments, the material of the first conductive member 15 may be the same as or different from the material of the corresponding conductive module.

In some embodiments, the first conductive member 15 is disposed, so that the conductive module of the optical engine 4 may pass through the via 121, and the corresponding conductive module of the optical engine 4 may be separately connected to the electrical component through the first conductive member 15, so as to facilitate wiring in the near-to-eye display assembly 1, thereby making the connection between the optical engine 4 and the electrical component more diversified, and improving the convenience of the connection between the optical engine 4 and the electrical component. In some embodiments, the first wiring groove 1212 is communicated with the via 121. By disposing the first wiring groove 1212, the via 121 only needs to be connected to the installation groove 111 and the first wiring groove 1212, which may facilitate the setting of the via 121.

As illustrated in FIGS. 3 and 6, in some embodiments, the via 121 includes a first via 1211 and a second via 1213 spaced apart from each other. The first via 1211 and the second via 1213 are respectively configured for the corresponding conductive module to pass through and be connected to the electrical component. One end of the first via 1211 is connected to the installation groove 111, and the other end of the first via 1211 is connected to the outer wall of the second section 12 and connected to the first wiring groove 1212.

The first via 1211 and the second via 1213 are two vias that are spaced apart from each other, which means that the first via 1211 and the second via 1213 are at least partially non overlapping. The first via 1211 and the second via 1213 are at least partially non overlapping, which refers to that the first via 1211 and the second via 1213 may be disposed parallel to each other, or not parallel to each other. The first via 1211 and the second via 1213 may be connected to each other and not parallel to each other. The first via 1211 and the second via 1213 are respectively configured for multiple conductive modules to pass through, so that the multiple conductive modules may be disposed independently of each other, or multiple conductive modules may be disposed in different directions.

The first via 1211 is communicated with the outer wall surface of the installation groove 111 and the second section 12, so that some conductive modules may extend in a direction of an angle with the axis of the installation groove 111 within the first via 1211. An end of the first via 1211 that is away from the installation groove 111 is communicated with the first wiring groove 1212 at the outer wall of the second section 12, so that the conductive module in the first via 1211 may extend to the outer wall of the second section 12. In some embodiments, at least part of the first conductive member 15 is located in the first wiring groove 1212. The first via 1211 may extend to the outer wall of the second section 12, thus the first conductive member 15 may extend to the outer wall position of the second section 12 to facilitate the positioning and installation of the second conductive member. In some embodiments, taking the second conductive member being the metal sheet as an example, the second conductive member may extend along the axis of the second section 12. One end of the second conductive member may be connected to the battery 3, the other end of the second conductive member is embedded in the first wiring groove 1212, and may be electrically connected to the conductive module of the second via 1213. In some embodiments, the second via 1213 may pass through the installation base 10 along a direction parallel to the axis of the installation groove 111, and the second via 1213 may also pass through the installation base 10 along other directions. In some embodiments, the first via 1211 and the second via 1213 may be straight holes or have other shapes. The shape and/or size of the first via 1211 and the second via 1213 may be the same or different.

As illustrated in FIGS. 7, 8, and 9, in some embodiments, the first conductive member 15 includes a connecting part 151 and an annular part 152 connected to the connecting part 151. At least part of the connecting part 151 is embedded in the first wiring groove 1212 and configured to be connected to the conductive module of the optical engine 4, and the annular part 152 is configured to sleeve on the periphery of the electrical component.

At least part of the annular part 152 is hollow, and a cavity is formed inside the annular part 152 to accommodate the electrical component. The connecting part 151 may be configured to connect the annular part 152 and the conductive module, so that the electrical component may be sequentially electrically connected to the corresponding conductive module through the annular part 152 and the connecting part 151. In some embodiments, the annular part 152 may be integrated with the connecting part 151, or the annular part 152 may be separated from the connecting part 151 and connected to each other. In some embodiments, the connecting part 151 may be a protruding structure protruding on the annular part 152, and the end of the connecting part away from the annular part may be embedded in the first wiring groove 1212. The connecting part 151 may also be the annular structure, so that the connecting part 151 is sleeved on the periphery of the second section 12, and the first wiring groove 1212 may be a circular groove surrounding the periphery of the second section 12.

In some embodiments, the annular part 152 and the connecting part 151 cooperate with each other, so that the annular part 152 may be configured as the intermediate connector between the corresponding conductive module and the electrical component, so as to increase a connection area between the conductive module and the electrical component. Taking the electrical component being the battery 3 as an example, the end face of one side of the battery 3 that is away from the optical engine 4 may be one of the poles, and the annular part 152 may be configured to connect the conductive module with the corresponding electrode of the battery 3. In some embodiments, a side wall of battery 3 may also serve as one of the poles, and the annular part 152 may be electrically connected to the side wall of the battery 3, to enable the battery 3 to supply power to the optical engine 4.

In some embodiments, the near-to-eye display assembly 1 includes a power module formed by multiple batteries 3. The multiple batteries 3 may be arranged and connected in series along the first direction parallel to the axial direction of the installation groove 111. The power module has a head end battery and an end battery. The head end battery may form the negative pole of the power module, and the end battery may form the positive pole of the power module. The annular part 152 may be sleeved on the periphery of multiple batteries 3, and a side wall of the end battery may serve as the positive pole of the power module. The annular part 152 may be electrically connected to the side wall of the end battery. An insulation layer may be disposed between the annular part 152 and other batteries. In some embodiments, the annular part 152 may be a closed annular structure, and the annular part 152 may also be a locally disconnected annular structure.

As illustrated in FIGS. 5, 6, 8, and 9, in some embodiments, the second section 12 also defines a second wiring groove 1214 that is communicated with the second via 1213 and the first electrical component storing chamber 142. The second wiring groove 1214 is configured for corresponding conductive modules to pass through and be connected to the electrical component. The second wiring groove 1214 is located at one end of the second section 12 away from the first section 11.

In some embodiments, the second wiring groove 1214 may be configured for the corresponding conductive module to pass through, so as to facilitate wiring of the conductive module when needed, so that the conductive module may better adapt to the shape of the installation base 10 and the position of the electrical components in the first electrical component storing chamber 142. The second section 12 has an end face that is away from the first section 11. In some embodiments, the second wiring groove 1214 is disposed at one end of the second section 12 that is away from the first section 11, so as to directly connect the electrical component in the first electrical component storing chamber 142 to the conductive module in the second wiring groove 1214. In some embodiments, the second wiring groove 1214 may be the sinking groove or other shaped groove body.

In some embodiments, the near-to-eye display assembly 1 also includes the second conductive member (not shown in the figures) that is configured to be connected to the electrical component and corresponding conductive module. At least part of the second conductive member is located in the second wiring groove 1214.

The second conductive member serves as the intermediate connector between the electrical component and the corresponding conductive module. The second conductive member may be a conductive column, a pole piece, a wire, a circuit board, or a copper plating layer, etc. In some embodiments, the second conductive member is disposed, which may facilitate the electrical connection between the electrical component and the conductive module. The second wiring groove 1214 may accommodate the second conductive member, so that the second conductive member does not occupy the internal space of the first electrical component storing chamber 142, thereby helping to improve the stability of the electrical components inside the first electrical component storing chamber 142.

As illustrated in FIGS. 3, 6, and 7 to 9, in some embodiments, one of the first connecting part 14 and the installation base 10 is provided with a convex block 143, and the other of the first connecting part 14 and the installation base 10 defines a clamping groove 1216. The convex block 143 is clamped to the clamping groove 1216. In some embodiments, the first connecting part 14 and the installation base 10 are fixed to each other through the coordination of the convex block 143 and the clamping groove 1216. As illustrated in FIGS. 3 and 6, in some embodiments, the clamping groove 1216 may be defined on the second section 12 of the installation base 10, and the convex block 143 may be disposed on the first connecting part 14. The convex block 143 is clamped to the clamping groove 1216 to install the first connecting part 14 on the second section 12. As illustrated in FIGS. 7 to 10, in some embodiments, the clamping groove 1216 may be defined on the first connecting part 14, and the convex block 143 may be disposed on the second section 12, and the convex block 143 is clamped to the clamping groove 1216.

In some embodiments, the clamping groove 1216 may be the sinking groove, and the convex block 143 may be elastically clamped into the clamping groove 1216. In some embodiments, the clamping groove 1216 may be a groove extending along a predetermined direction, and the convex block 143 may slide along the predetermined direction in the clamping groove 1216 and be limited in the clamping groove 1216. The predetermined direction may be parallel to the axis of the first connecting part 14 or inclined to the axis of the first connecting part 14. In some embodiments, the convex block 143 may also be elastically clamped into the clamping groove 1216.

As illustrated in FIG. 7, in some embodiments, the clamping groove 1216 and a guide groove 1215 communicated with the clamping groove 1216 are defined on the inner wall surface of the accommodating groove 141. The axial directions of the clamping groove 1216 and the accommodating groove 141 form an angle. In some embodiments, the clamping groove 1216 is disposed on the first connecting part 14, and the convex block 143 is disposed on the installation base 10. The guide groove 1215 and the clamping groove 1216 are connected to each other, so that the convex block 143 may enter the clamping groove 1216 along the guide groove 1215. In some embodiments, the guide groove 1215 is configured to guide the convex block 143, so that the convex block 143 may move along the predetermined direction. In some embodiments, the guide groove 1215 may be disposed parallel to the axial direction of the accommodating groove 141. In some embodiments, the clamping groove 1216 is disposed at an angle with the axial direction of the accommodating groove 141, which means that the clamping groove 1216 has a first end connected to the guide groove 1215 and a second end away from the guide groove 1215. A direction from the first end to the second end is the second direction, and the second direction is not parallel or overlapping with the axial direction of the accommodating groove 141. In some embodiments, the guide groove 1215 is matched with the clamping groove 1216, it is easy to guide the convex block 143, so as to clamp the convex block 143 into the clamping groove 1216, limit the movement of the convex block 143 along the axis direction of the accommodating groove 141, thereby positioning the installation base 10. In some embodiments, the end of the guide groove 1215 away from the clamping groove 1216 may penetrate to the opening of the accommodating groove 141, and the convex block 143 may be embedded into the second end of the guide groove 1215 from the opening of the accommodating groove 141 and move along the guide groove 1215 towards the direction of the clamping groove 1216.

As illustrated in FIG. 10, in some embodiments, the difference from the previous embodiments is that the convex block 143 is disposed on the first connecting part 14, the clamping groove 1216 and the guide groove 1215 communicated with the clamping groove 1216 are defined on the second section 12. The length directions of the clamping groove 1216 and the accommodating groove 141 form an angle. In some embodiments, the end of the guide groove 1215 away from the clamping groove 1216 may be communicated with the end of the second section 12 away from the first section 11, so that the convex block 143 may be embedded into the guide groove 1215 from the end face of the second section 12 away from the first section 11 and move along the guide groove 1215 towards the clamping groove 1216.

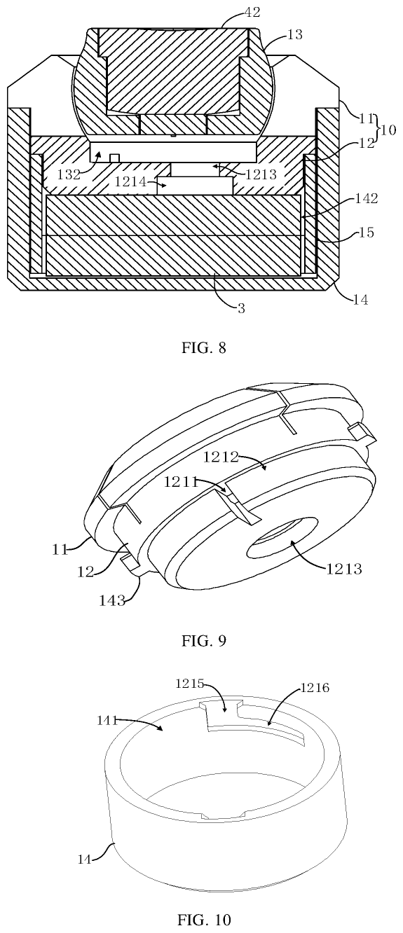

As illustrated in FIGS. 5 and 8, in some embodiments, the near-to-eye display assembly 1 further includes a fixed base 13, and the fixed base 13 is installed in the installation groove 111. The fixed base 13 defines a fixed groove 131 that is configured for installing the optical engine 4. The fixed groove 131 is also communicated with the first electrical component storing chamber 142. In some embodiments, the fixed base 13 may serve as the intermediate connector between the optical engine 4 and the installation base 10. The fixed base 13 may be fixedly connected to the installation base 10, and the fixed base 13 may also be movably installed on the installation base 10. In some embodiments, the fixed groove 131 may be a groove defined in the fixed base 13, and the shape and size of the fixed groove 131 may be adapted to the shape and size of the optical engine 4 to facilitate fixation of the optical engine 4. In some embodiments, the fixed base 13 has an opening communicated with the fixed groove 131 and the bottom wall opposite to the opening. The optical engine 4 may enter the fixed groove 131 through the opening of the fixed base 13, and the out-light surface of the optical engine 4 may be disposed on the same side as the opening. In some embodiments, the fixed base 13 is configured to form the intermediate connector that is configured for installing the optical engine 4, so as to facilitate necessary sealing and fixation of the optical engine 4. The fixed groove 131 is connected to the first electrical component storing chamber 142, which means that the fixed groove 131 may be connected to the first electrical component storing chamber 142 through a through hole or other structure that passes through the fixed base 13, so that the conductive module of the optical engine 4 may be electrically connected to the electrical component in the first electrical component storing chamber 142.

As illustrated in FIGS. 5 and 8, in some embodiments, a second electrical component storing chamber 132 is formed in the installation base 10. The second electrical component storing chamber 132 is communicated with the first electrical component storing chamber 142, and the second electrical component storing chamber 132 is further communicated with the fixing groove 131. In some embodiments, the second electrical component storing chamber 132 may be configured to accommodate a structure, such as the circuit board. In some embodiments, the second electrical component storing chamber 132 is communicated with the first electrical component storing chamber 142 to facilitate the electrical connection between the electrical component in the first electrical component storing chamber 142 and the circuit board or other component in the second electrical component storing chamber 132. In some embodiments, the fixed groove 131 may also be communicated with the first electrical component storing chamber 142 through the second electrical component storing chamber 132. The second electrical component storing chamber 132 is communicated with the fixed groove 131, which means that the second electrical component storing chamber 132 may be connected to the fixed groove 131 through the through hole or a groove structure. In some embodiments, the second electrical component storing chamber 132 has an opening away from the first electrical component storing chamber 142, and the opening of the second electrical component storing chamber 132 corresponds to the position of the fixed groove 131 and is communicated with the fixed groove 131. In some embodiments, the second electrical component storing chamber 132 may be formed in the second section 12 of the installation base 10. In some embodiments, the second section 12 defines the via 121 as described in any of the above embodiments, and the via 121 is configured for the conductive module of the light supply machine 4 to pass through and be connected to the electrical component in the second electrical component storing chamber 132. The end of the via 121 away from the first electrical component storing chamber 142 may be communicated with the second electrical component storing chamber 132.

In some embodiments, one of the outer wall surface of the fixed base 13 and the inner wall surface of the installation groove 111 is a convex arc surface, and the other of the outer wall surface of the fixed base 13 and the inner wall surface of the installation groove 111 is a concave arc surface. The installation groove 111 is configured to allow the fixed base 13 to rotate, to adjust a out-light angle of the optical engine 4. In some embodiments, the convex surface and the concave surface are compatible with each other, which means that the convex surface and the concave surface may fit together, so that the fixed base 13 may rotate in the installation groove 111 relative to the installation groove 111. When the fixed base 13 rotates relative to installation groove 111, the optical engine 4 on the fixed base 13 also rotates synchronously, which may cause the out-light angle of the optical engine 4 to change synchronously. In some embodiments, the out-light angle of the optical engine 4 is adjusted, so that the position of the light ray relative to the human eye's field of view may be adjusted, to accurately adjust the position of the light, thereby meeting different people with different pupil distances or field of view ranges, and meeting the viewing needs and preferences of different users. On the other hand, flexible location testing may also be provided in the early stages of research and development to achieve the expected design results.

In some embodiments, the outer surface of the fixed base 13 may be at least partially spherical, and the inner wall surface of the installation base 10 is the concave arc surface, so that the fixed base 13 may rotate relative to the installation base 10 in the installation base 10. In some embodiments, the outer surface of the fixed base 13 may also be the concave arc surface, and the inner wall surface of the installation base 10 may be the convex arc surface, so that the fixed base 13 may rotate relative to the installation base 10 in the installation base 10.

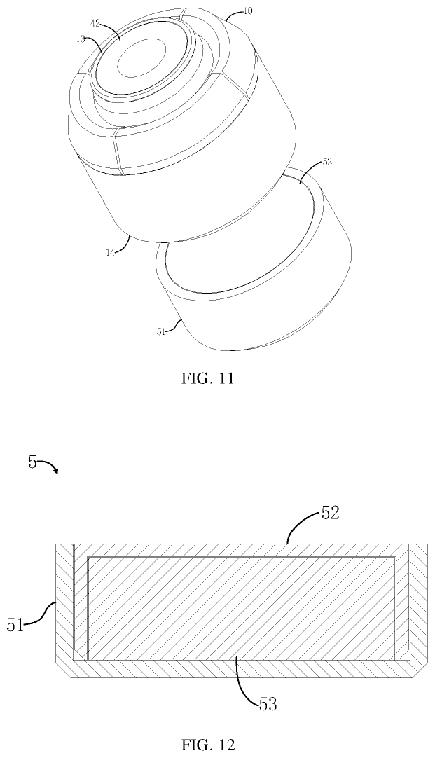

As illustrated in FIG. 11, on the basis of the aforementioned near-to-eye display assembly 1, the present disclosure further provides a near-to-eye display device for the optical lens 2. The near-to-eye display device includes the near-to-eye display assembly 1 in any one of the above embodiments, and the first connecting part 14 of the near-to-eye display assembly 1 is connected to the optical lens 2. In some embodiments, the first connecting part 14 may be fixedly connected to the optical lens 2 or detachably connected to the optical lens 2. The near-to-eye display device in the present disclosure includes the near-to-eye display assembly 1 in any one of the above embodiments, as well as the technical effects in any one of the above embodiments, which may not be repeated here.

In some embodiments, the first connecting part 14 of the near-to-eye display assembly 1 is connected to a first side of the optical lens 2. The near-to-eye display device further includes a second connecting part 5 opposite to the first connecting part 14. The second connecting part 5 is configured to connect to a second side of the optical lens 2, and the first side and the second side of the optical lens 2 are two opposite sides. The first connecting part 14 and the second connecting part 5 are configured to grip the optical lens 2 and allow the installation base 10 to move on the optical lens 2, thereby adjusting the position of optical engine 4 relative to the optical lens 2.

In some embodiments, the second connecting part 5 may be a component connected and fixed to the first connecting part 14. For example, the first connecting part 14 may be fixed to the second connecting part 5 by bonding, clamping, threading, etc. The first connecting part 14 may also be connected to the second connecting part 5 through the intermediate connector. In some embodiments, the first connecting part 14 and the second connecting part 5 may be independent components, and the first connecting part 14 may cooperate with the second connecting part 5 to serve as clamping or adsorption components.

As illustrated in FIGS. 11 and 12, in some embodiments, at least part of the second connecting part 5 is made of a magnetic material. In some embodiments, entire second connecting part 5 may be made of the magnetic material or part of the second connecting part 5 is made of the magnetic material. As shown in FIG. 12, the second connecting part 5 includes a sleeve 51 and a magnet 53 embedded inside the sleeve 51. Since the battery 3 and other structures may be adsorbed by the magnet 53, when the first connecting part 14 and the second connecting part 5 are respectively disposed on two opposite sides of the optical lens 2, the second connecting part 5 may adsorb the first connecting part 14 at a predetermined position on the optical lens 2.

In some embodiments, a protective component 52 is disposed on the second connecting part 5, and the protective component 52 may be a protective film or a protective cover. The protective component 52 is configured to block between the magnet 53 and the optical lens 2 to reduce wear on the optical lens 2. In some embodiments, one end of the sleeve 51 defines an opening that is configured for allowing the magnet 53 to pass through and be embedded in the sleeve 51. The protective component 52 includes a protective layer and a fixed layer connected to the protective layer. The protective layer covers the opening of the sleeve 51 to block between the magnet 53 and the optical lens 2. The fixed layer and the sleeve 51 are sleeved on each other, to improve the sealing property of the second connecting part 5.

On the basis of the above near-to-eye display device, the present disclosure further provides a wearable device, including the near-to-eye display assembly 1 or the near-to-eye display device as described in any one of the above embodiments.

In the above scheme, by disposing the first electrical component storing chamber on the first connecting part, an electrical component such as the battery or the like may be directly installed in the first electrical component storing chamber, thereby facilitating the integration of the electrical component on the near-to-eye display assembly, reducing the additional functional structure on the outside of the optical lens for installing the electrical component, simplifying the structure of the near-to-eye display assembly, and facilitating the assembly of the near-to-eye display assembly on the near-to-eye display device.

The above description are only some embodiments of the present disclosure, and are not intended to limit the scope of the present disclosure. Any equivalent structure or equivalent flow transformation made by using the contents of the specification and accompanying drawings of the present disclosure, or directly or indirectly applied to other related technical fields, is included in the scope of the patent protection of the present disclosure.

What is claimed is:

1. A near-to-eye display assembly for an optical lens, comprising:
an installation base, configured for installing an optical engine; and
a first connecting part, connected to the installation base and configured for connecting to the optical lens; wherein the first connecting part defines an accommodating groove, the installation base comprises a first section and a second section connected to the first section, the first section defines an installation groove configured for installing the optical engine, and the second section is embedded in the accommodating groove; and a first electrical component storing chamber configured for installing an electrical component is formed between the accommodating groove and the second section, and the electrical component is configured to be electrically connected to the optical engine.

2. The near-to-eye display assembly according to claim 1, wherein the first electrical component storing chamber is formed between an end face of a side of the second section away from the first section and a bottom wall of the accommodating groove; or
the first electrical component storing chamber is located on the side of the second section away from the first section.

3. The near-to-eye display assembly according to claim 1, wherein a via is defined in the installation base and configured for accommodating a conductive module of the optical engine, the installation groove is communicated with the first electrical component storing chamber through the via, and the conductive module is configured to be connected to the electrical component; and at least one of the second section and the first connecting part defines a first wiring groove that is communicated with the first electrical component storing chamber and the via, and the first wiring groove is configured for the conductive module to pass through and be connected to the electrical component.

4. The near-to-eye display assembly according to claim 3, wherein the number of the conductive module is multiple, and the multiple conductive modules are configured to be connected to the electrical component, respectively; the near-to-eye display assembly further comprises:
a first conductive member, configured to connect the electrical component with a corresponding conductive module, wherein at least part of the first conductive member is located in the first wiring groove.

5. The near-to-eye display assembly according to claim 4, wherein the via comprises a first via and a second via spaced apart from each other, the first via and the second via are respectively configured for the corresponding conductive modules to pass through and be connected to the electrical component; one end of the first via is communicated with the installation groove, and the other end of the first via passes through an outer wall of the second section and is connected to the first wiring groove.

6. The near-to-eye display assembly according to claim 5, wherein the first conductive member comprises a connecting part and an annular part connected to the connecting part, at least part of the connecting part is embedded in the first wiring groove and configured for connecting the conductive module of the optical engine, and the annular part is configured to sleeve on a periphery of the electrical component.

7. The near-to-eye display assembly according to claim 5, wherein the second section further defines a second wiring groove that is communicated with the second via and the first electrical component storing chamber, the second wiring groove is configured for the corresponding conductive module to pass through and connect the electrical component, and the second wiring groove is located at one end of the second section away from the first section; and
the near-to-eye display assembly further comprises a second conductive member, the second conductive member is configured to connect the electrical component and the corresponding conductive module, and at least part of the second conductive member is located in the second wiring groove.

8. The near-to-eye display assembly according to claim 2, wherein one of the first connecting part and the installation base is provided with a convex block, the other of the first connecting part and the installation base defines a clamping groove, and the convex block is clamped to the clamping groove.

9. The near-to-eye display assembly according to claim 8, wherein the clamping groove and a guide groove communicated with the clamping groove are defined on an inner wall surface of the accommodating groove, and the clamping groove is disposed at an angle with an axial direction of the accommodating groove; or
the second section defines the clamping groove and a guide groove communicated with the clamping groove, and the clamping groove is disposed at the angle with the axial direction of the accommodating groove.

10. The near-to-eye display assembly according to claim 1, wherein the near-to-eye display assembly further comprises a fixed base, the fixed base is installed in the installation groove, the fixed base defines a fixed groove configured for installing the optical engine, and the fixed groove is further communicated with the first electrical component storing chamber;
a second electrical component storing chamber is defined on the installation base and communicated with the first electrical component storing chamber, and the second electrical component storing chamber is further communicated with the fixed groove; and/or
one of an outer wall surface of the fixed base and an inner wall surface of the installation groove is a convex arc surface, the other of the outer wall surface of the fixed base and the inner wall surface of the installation groove is a concave arc surface, and the installation groove is configured to allow the fixed base to rotate in the installation groove, to adjust an out-light angle of the optical engine.

11. A near-to-eye display device, comprising:
an optical lens; and
a near-to-eye display assembly, comprising:
an installation base, configured for installing an optical machine; and
a first connecting part, connected to the installation base and configured for connecting to the optical lens; wherein the first connecting part defines an accommodating groove, the installation base comprises a first section and a second section connected to the first section, the first section defines an installation groove configured for installing the optical machine, and the second section is embedded in the accommodating groove; and a first electrical component storing chamber configured for installing an electrical component is formed between the accommodating groove and the second section, and the electrical component is electrically connected to the optical machine;
wherein the first connecting part of the near-to-eye display assembly is connected to the optical lens.

12. The near-to-eye display device according to claim 11, wherein the first connecting part of the near-to-eye display assembly is connected to a first side of the optical lens, and the near-to-eye display device further comprises:
a second connecting part, opposite to the first connecting part and configured to connect to a second side of the optical lens, wherein the first side and the second side of the optical lens are two opposite sides, the first connecting part and the second connecting part are configured to grip the optical lens and allow the installation base to move on the optical lens to adjust a position of the optical engine relative to the optical lens, and at least part of the second connecting part is made of a magnetic material.

13. The near-to-eye display device according to claim 11, wherein the first electrical component storing chamber is formed between an end face of a side of the second section away from the first section and a bottom wall of the accommodating groove; or
the first electrical component storing chamber is located on the side of the second section away from the first section.

14. The near-to-eye display device according to claim 11, wherein a via is defined in the installation base and configured for accommodating conductive modules of the optical machine, the installation groove is communicated with the first electrical component storing chamber through the via, and the conductive modules are configured to be connected to the electrical component; and at least one of the second section and the first connecting part defines a first wiring groove that is communicated with the first electrical component storing chamber and the via, and the first wiring groove is configured for the conductive modules to pass through and be connected to the electrical component.

15. The near-to-eye display device according to claim 14, wherein the number of the conductive modules is multiple, and the multiple conductive modules are configured to be connected to the electrical component, respectively; the near-to-eye display assembly further comprises:
a first conductive member, configured to connect the electrical component with a corresponding conductive module, wherein at least part of the first conductive member is located in the first wiring groove.

16. The near-to-eye display device according to claim 15, wherein the via comprises a first via and a second via spaced apart from each other, the first via and the second via are respectively configured for the corresponding conductive module to pass through and be connected to the electrical component; one end of the first via is communicated with the installation groove, and the other end of the first via passes through an outer wall of the second section and is connected to the first wiring groove.

17. The near-to-eye display device according to claim 16, wherein the first conductive member comprises a connecting part and an annular part connected to the connecting part, at least part of the connecting part is embedded in the first wiring groove and configured for connecting the conductive module of the optical machine, and the annular part is configured to sleeve on a periphery of the electrical component.

18. The near-to-eye display device according to claim 16, wherein the second section further defines a second wiring groove that is communicated with the second via and the first electrical component storing chamber, the second wiring groove is configured for the corresponding conductive module to pass through and connect the electrical component, and the second wiring groove is located at one end of the second section away from the first section; and
the near-to-eye display assembly further comprises a second conductive member, the second conductive member is configured to connect the electrical component and the corresponding conductive module, and at least part of the second conductive member is located in the second wiring groove.

19. The near-to-eye display device according to claim 13, wherein one of the first connecting part and the installation base is provided with a convex block, the other of the first connecting part and the installation base defines a card groove, and the convex block is clamped to the card groove.

20. A wearable device, comprising:
a near-to-eye display device, comprising:
an optical lens; and
a near-to-eye display assembly, comprising:
an installation base, configured for installing an optical machine; and
a first connecting part, connected to the installation base and configured for connecting to the optical lens; wherein the first connecting part defines an accommodating groove, the installation base comprises a first section and a second section connected to the first section, the first section defines an installation groove configured for installing the optical machine, and the second section is embedded in the accommodating groove; and a first electrical component storing chamber configured for installing an electrical component is formed between the accommodating groove and the second section, and the electrical component is electrically connected to the optical machine;
wherein the first connecting part of the near-to-eye display assembly is connected to the optical lens.
